(19) United States
(12) Patent Application Publication
(10) Pub. No.: US 2016/0037414 A1
(43) Pub. Date: Feb. 4, 2016

(54) TRANSMISSION CONTROL FOR USER EQUIPMENT

(71) Applicant: QUALCOMM Incorporated, San Diego, CA (US)

(72) Inventors: Thiagarajan SIVANADYAN, Boulder, CO (US); Prasad KADIRI, San Diego, CA (US); Chintan Shirish SHAH, San Diego, CA (US); Neelakanta Venkata Seshachalam CHIMMAPUDI, San Diego, CA (US); Ammar Taiyebi KITABI, San Diego, CA (US); Pavan KAIVARAM, San Diego, CA (US); Vidya Sagar PUTTA, San Diego, CA (US); Kamalakar GANTI, San Diego, CA (US)

(21) Appl. No.: 14/814,391

(22) Filed: Jul. 30, 2015

Related U.S. Application Data
(60) Provisional application No. 62/031,823, filed on Jul. 31, 2014.

(51) Int. Cl. H04W 36/14; H04L 1/18; H04W 76/02

(52) U.S. Cl. CPC H04W 36/14; H04W 76/02; H04L 1/1812

(57) ABSTRACT

A method, an apparatus, and a computer program product for wireless communication are provided. The apparatus establishes a wireless connection to a first network, determines a start time of a tune away procedure, enters a transmission freeze state for a first predetermined interval prior to the start time of the tune away procedure, tunes away from the first network for a second predetermined interval, and tunes back to the first network after the second predetermined interval.

### CROSS-REFERENCE TO RELATED APPLICATION(S)

This application claims the benefit of U.S. Provisional Application Ser. No. 62/031,823, entitled “TRANSMISSION CONTROL FOR USER EQUIPMENT” and filed on Jul. 31, 2014, which is expressly incorporated by reference herein in its entirety.

### BACKGROUND

1. Field

The present disclosure relates generally to communication systems, and more particularly, but not exclusively to optimizing LTE data performance for single radio hybrid tune away devices using a transmission blanking mechanism.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus configured to establish a wireless connection to a first network, determine a start time of a tune away procedure, enter a transmission freeze state for a first predetermined interval prior to the start time of the tune away procedure, tune away from the first network for a second predetermined interval, and tune back to the first network after the second predetermined interval.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a range expanded cellular region in a heterogeneous network.

FIG. 8 is a flow chart of a method of wireless communication.

FIG. 9 is a flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

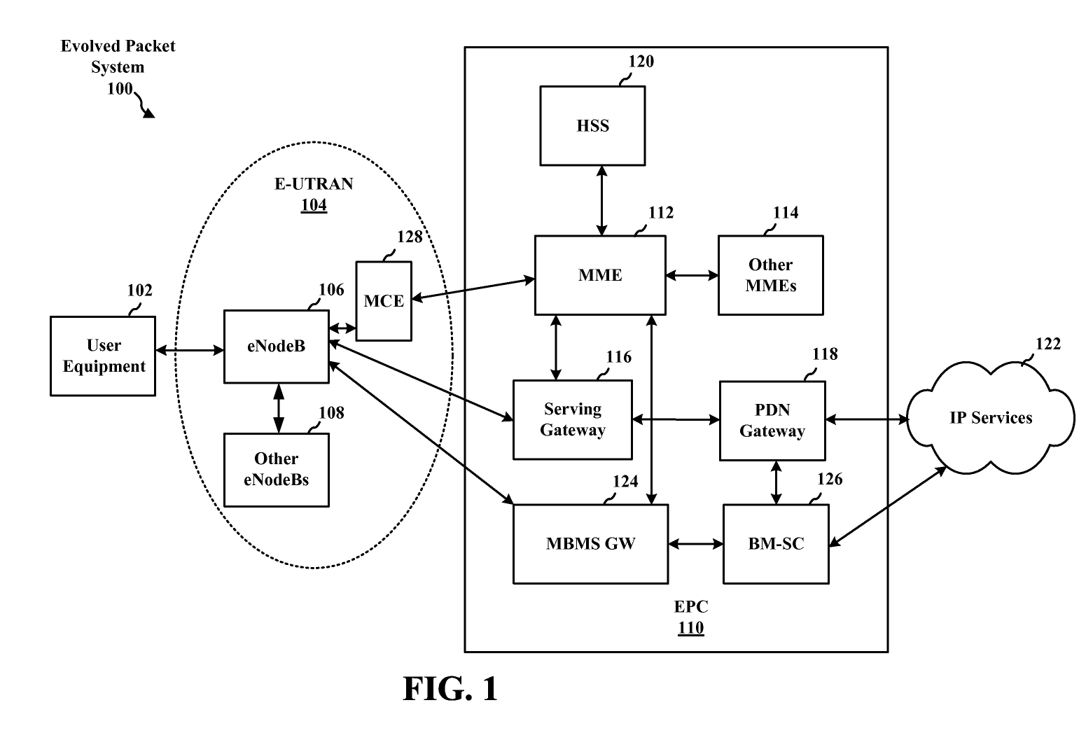

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

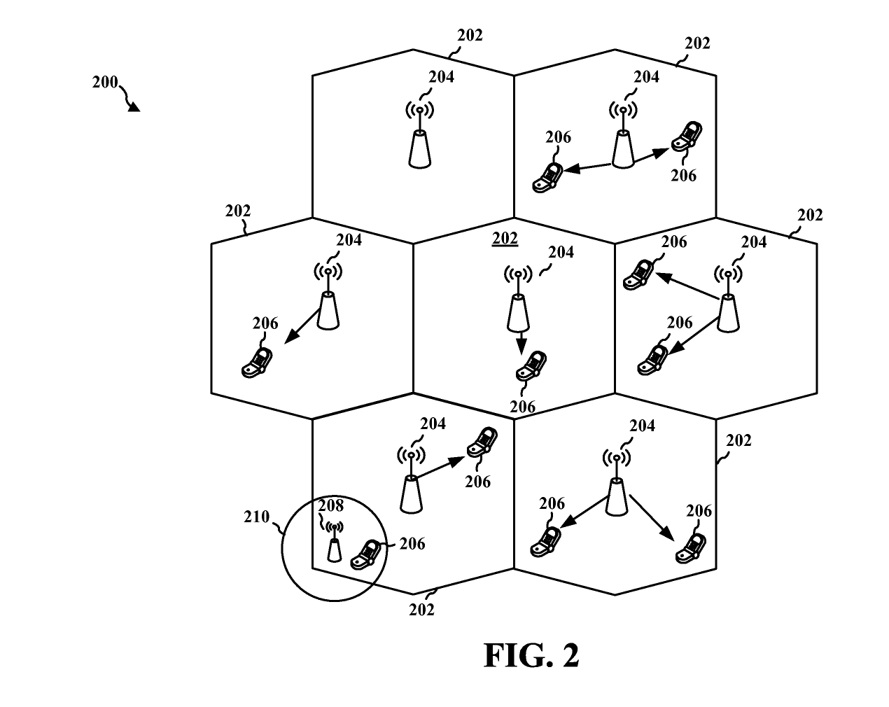

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

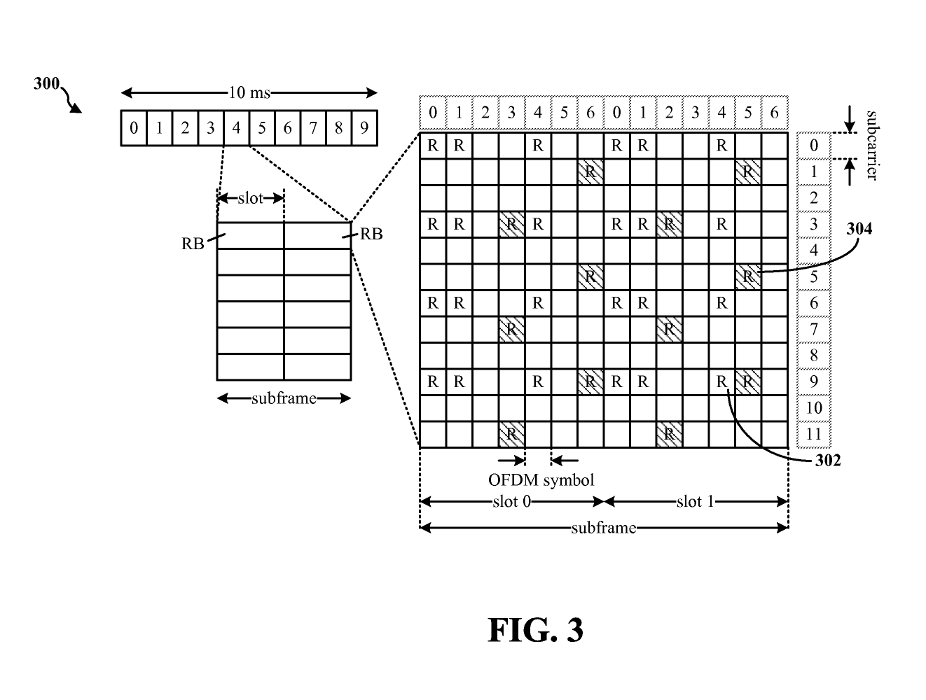

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

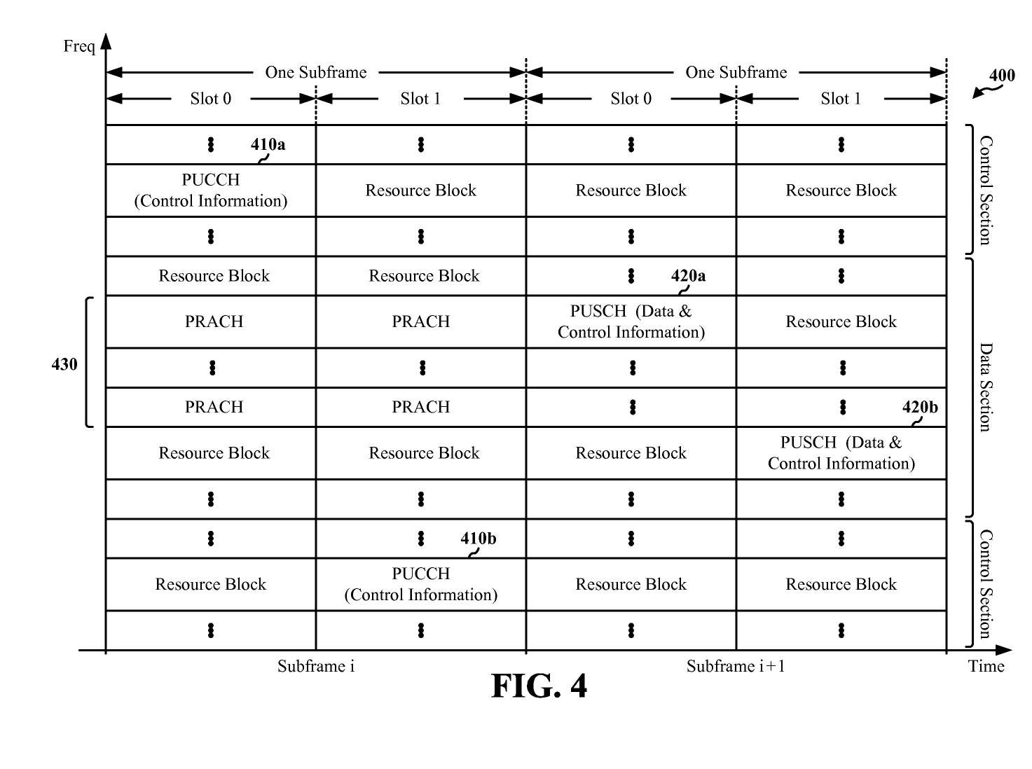

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

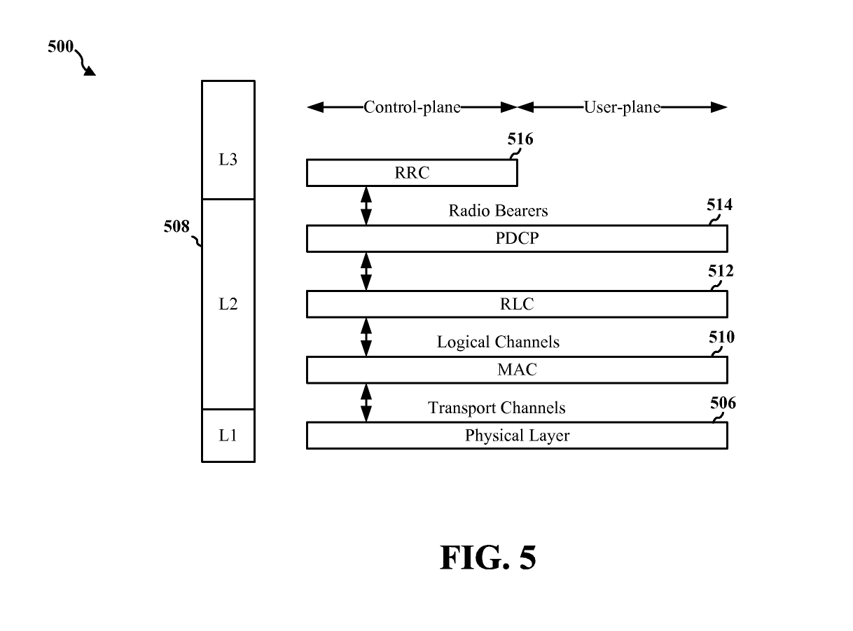

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

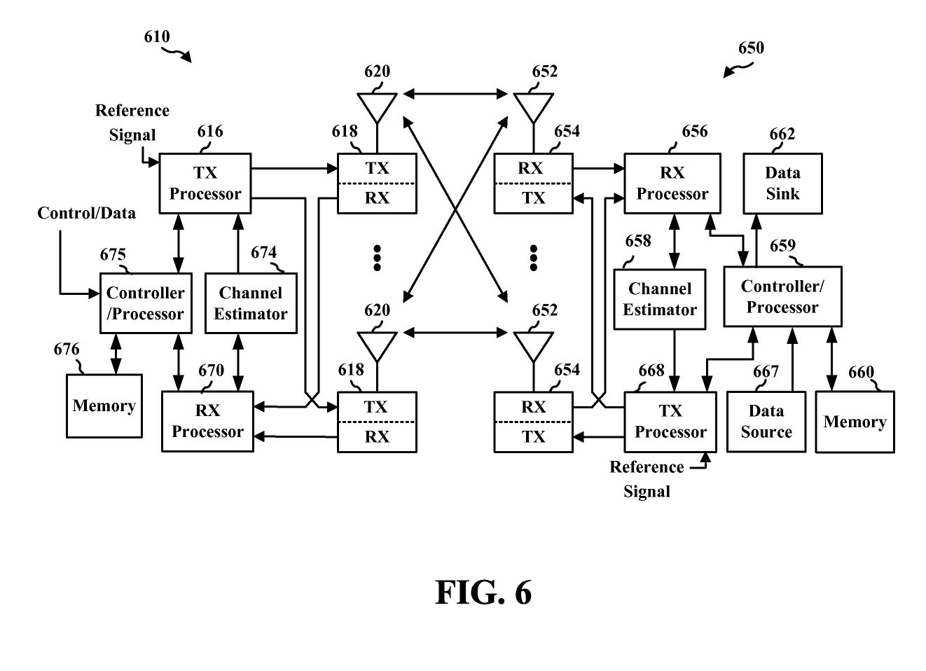

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

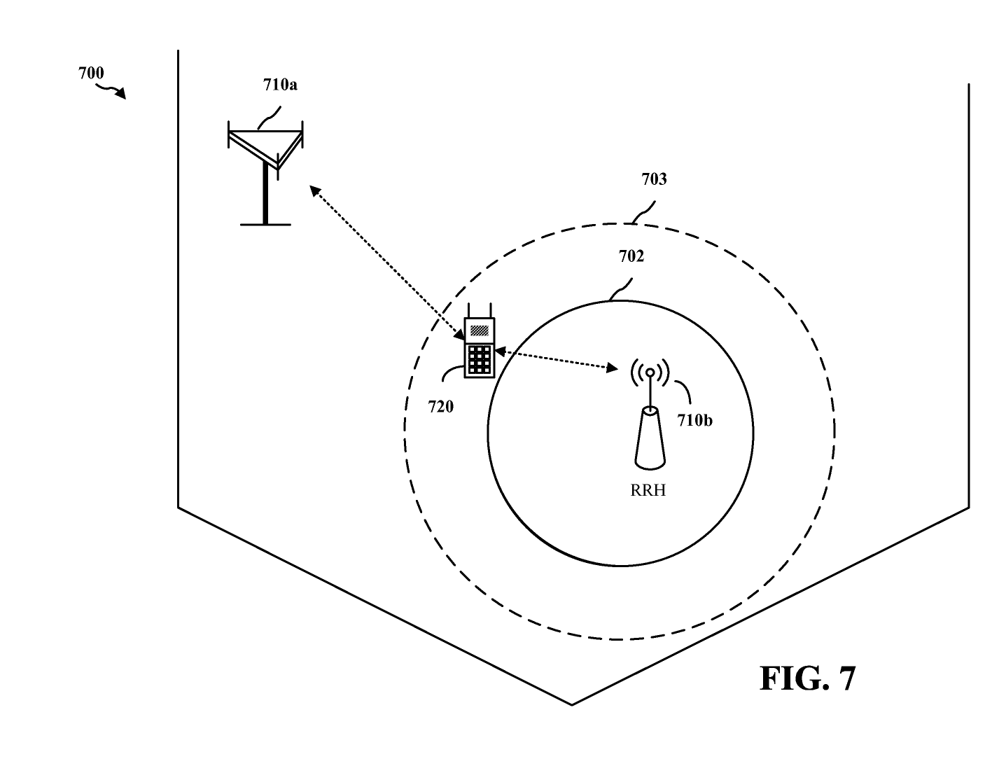

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and through interference cancellation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703.

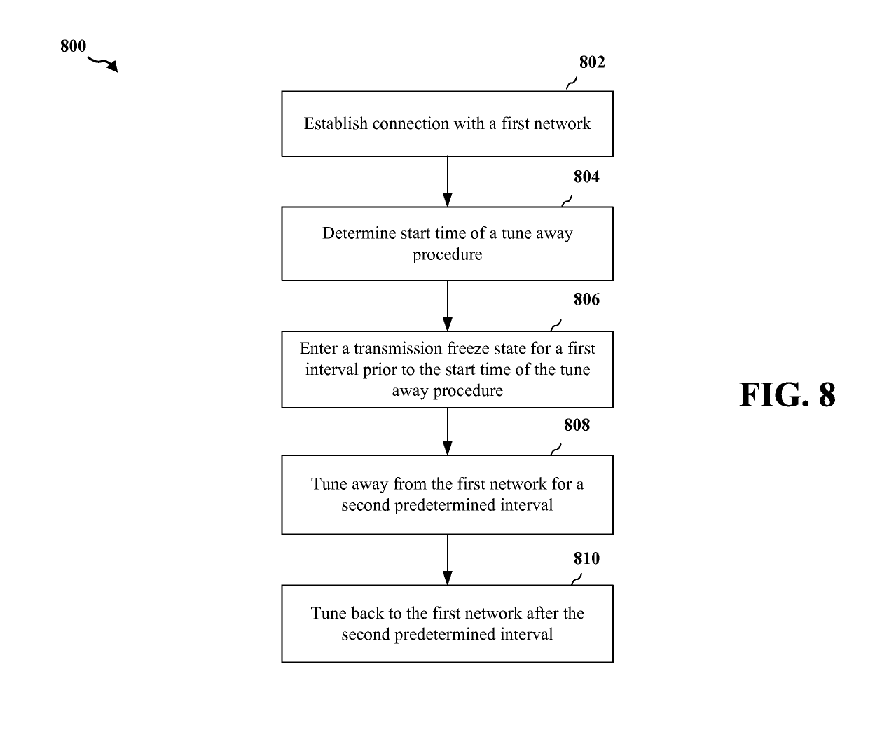

FIG. 8 illustrates a flow chart for performing transmission control of a hybrid tune away user equipment (UE) as represented by block 800. As represented by block 802, the UE may establish a connection with a first network, such as an LTE network. A start time for a tune away procedure can be determined as represented at block 804. Before the UE begins the tune away procedure, the eNB may schedule DL PDSCH data based on DL data buffer availability.

Prior to the start of the tune away procedure, at block 806, the UE can enter a transmission freeze state (e.g., Tx blanking) for a predetermined interval. For example, the predetermined interval of the transmission freeze state can be 4-5 ms immediately preceding the start of the tune away procedure. The predetermined interval of the transmission freeze state may be configurable using the software configuration parameters of the UE. The transmission freeze state can include disabling the UE transmitter just before the start of the tune away procedure. In aspect, the UE can enter the transmission freeze state based on signaling received from the eNB. While in the transmission freeze state, the UE can continue to receive and decode DL PDSCH scheduled data, but may not transmit any UL ACK/NACK for that data. In other words, during the transmission freeze state, the UE can successfully receive DL PDSCH data from the eNB but not provide any UL ACK/NACK to the eNB for this data. Consequently, the eNB will not receive any UL ACK/NACK for the data scheduled during the time period immediately preceding the UE tune away period, and will retransmit the same DL PDSCH data during the UE tune away period. Therefore, the eNB will not transmit any new data to the UE while the UE is in the transmission freeze state, and no data will be missed.

As represented by block 808, the UE can tune away from the first network for a second predetermined time period based on a tune away procedure. For example, the tune away procedure can include that the UE periodically tune to a second network at predetermined time periods to determine if a page has been received from the second network. The second network can include at least one of 1×RTT, GSM, TD-SCDMA, or other 3G technologies. After the predetermined time period the UE can tune back to the first network, as represented by block 810.

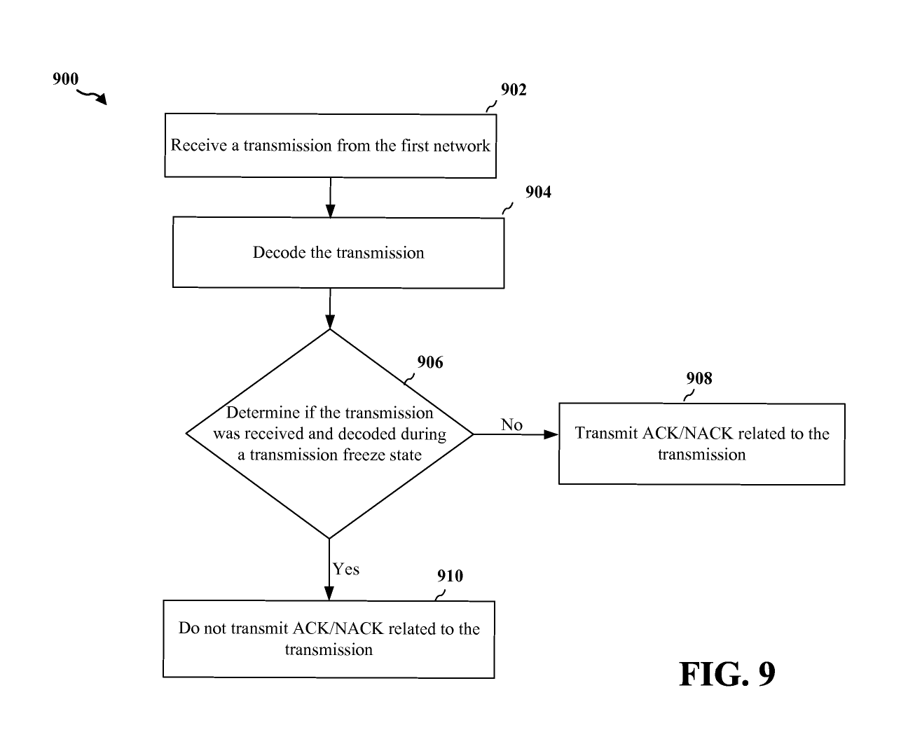

FIG. 9 illustrates a process 900 associated with a HARQ process implemented during the transmission freeze state detailed in FIG. 8. As represented by block 902, the UE can receive a transmission from an eNB. The UE can decode the received transmission as represented by block 904. As represented by block 906, the UE can determine if the transmission was received and decoded while in a transmission freeze state. If the UE determines that the transmission was received and decoded while not in the transmission freeze state, as represented by block 908, the UE can transmit an ACK/NACK related to the received and decoded transmission. However, if the UE determines that the transmission was received and decoded while in the transmission freeze state, as represented by block 910, then the UE may not send an ACK/NACK related to the transmission. Consequently, when the UE is in the transmission freeze state, the eNB will not receive an UL ACK/NACK for transmissions sent to the UE during this time period. Since no UL ACK/NACK is received, the eNB can then retransmit the same transmission to the UE, which is now tuned away to the second network. This may prevent the eNB from transmitting new DL PDSCH data to the UE during the tune away period. As such, after the UE tunes back to the LTE network, the UE will not send an RLC PDU NACK for data received during the transmission freeze period.

The processes described with reference to FIGS. 8 and 9 can improve DL LTE data performance by forcing the eNB to transmit old data (e.g., in a retransmission) when the UE is tuned away to the second network. Thus, a reduction in DL RLC retransmission can be provided and a loss of DL data during tune away gaps can be reduced, which may result in improved DL LTE data performance. Furthermore, RLC retransmission may be reduced by having no new HARQ processes that originate while the UE is tuned away to the second network. In an instance where HARQ process initiates before the start of the tune away procedure and continues into the tune away procedure, the DL physical packet will have been successfully received by the UE. Thus, by implementing the procedure of the present disclosure, the number of missed data transmissions can be reduced while the UE is tuned away from the first network.

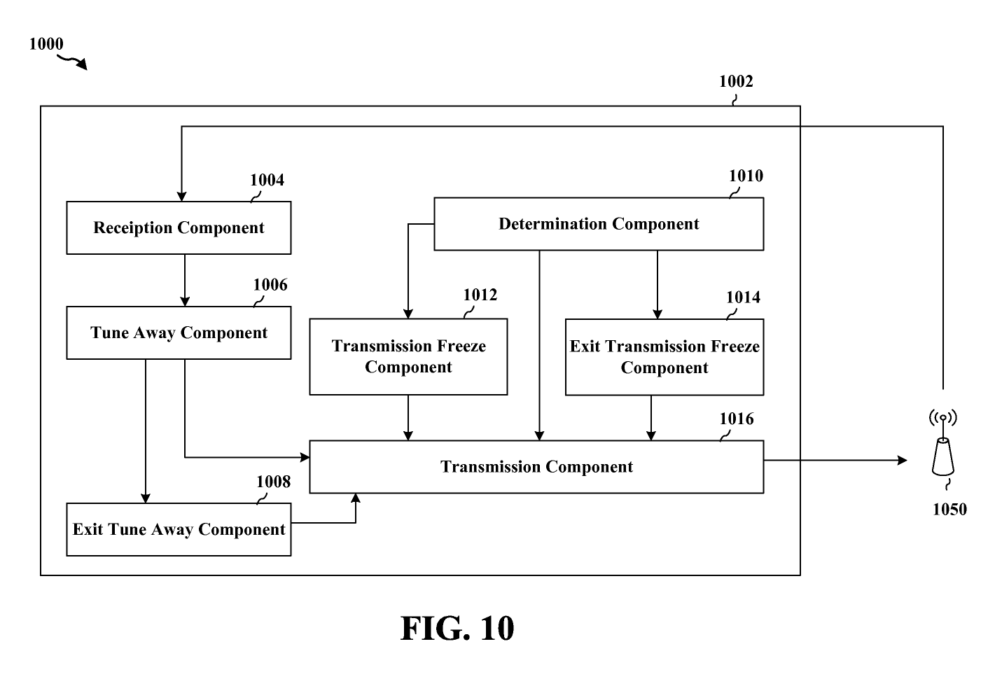

FIG. 10 is a conceptual data flow diagram 1000 illustrating the data flow between different modules/means/components in an exemplary apparatus 1002 that can communicate with an eNB 1050. In an aspect, the eNB 1050 can be part of a first network or a second network. The apparatus 1002 may be, for example, a UE. The apparatus includes a reception component 1004 that receives pages or data from the first and/or second network, a tune away component 1006 that tunes away from the first network, an exit tune away component 1008 that tunes back to the first network, a determination component 1010 that determines if a transmission was received during a transmission freeze state, a transmission freeze component 1012 that enters a transmission freeze state, an exit transmission freeze component 1014 that exits the transmission freeze state, and a transmission component 1016 that transmits data to the first network and/or the second network.

The reception component 1004 can establish a connection to a first network and/or second network. For example, the first network and/or second network may be an LTE network, a 1×RTT network, a TD-SCDMA network, an UTRA network, a GSM network Global System for Mobile Communications (GSM) employing TDMA, an E-UTRA network, an IEEE 802.11 (Wi-Fi) network, and IEEE 802.16 (WiMAX) network, an IEEE 802.20 network, or Flash-OFDM network. The reception component 1004 can receive pages or data from a first network and/or a second network. For example, the reception component 1004 can receive pages or data from the eNB 1050.

The tune away component 1006 enables a tune away protocol such that at predetermined time periods the UE 1002 tunes away from the first network to determine if a page has been received by a second network. For example, the second network can include an LTE network, a 1×RTT network, a TD-SCDMA network, an UTRA network, a GSM network Global System for Mobile Communications (GSM) employing TDMA, an E-UTRA network, an IEEE 802.11 (Wi-Fi) network, and IEEE 802.16 (WiMAX) network, an IEEE 802.20 network, or Flash-OFDM network. The reception component 1004 can receive pages or data from a first network and/or a second network. For example, the reception component 1004 can receive pages or data from the eNB 1050.

The exit tune away component 1008 tunes back to the first network after the predetermined time period. For example, the UE 1002 can tune back to the LTE network, the 1×RTT network, the TD-SCDMA network, an UTRA network, the GSM network Global System for Mobile Communications (GSM) employing TDMA, the E-UTRA network, the IEEE 802.11 (Wi-Fi) network, the IEEE 802.16 (WiMAX) network, an IEEE 802.20 network, or the Flash-OFDM network after the predetermined time period.

The determination component 1010 can determine a start time for a tune away procedure and determine an end time for the tune away procedure.

The transmission freeze component 1012 can enter a transmission freeze state (e.g., Tx blanking) for a predetermined interval prior to the start of the tune away procedure. For example, the predetermined interval of the transmission freeze state can be 4-5 ms immediately preceding the start of the tune away procedure. The predetermined interval of the transmission freeze state may be configurable using the software configuration parameters of the UE. The transmission freeze state can include disabling the UE transmission component 1016 just before the start of the tune away procedure. In aspect, the UE can enter the transmission freeze state based on signaling received from the eNB that is received at the reception component 1004. While in the transmission freeze state, the UE can continue to receive and decode DL PDSCH scheduled data at the reception component 1004, but may not transmit any UL ACK/NACK for that data. In other words, during the transmission freeze state, the UE can successfully receive DL PDSCH data from the eNB but not provide any UL ACK/NACK to the eNB for this data. Consequently, the eNB will not receive any UL ACK/NACK for the data scheduled during the time period immediately preceding the UE tune away period, and will retransmit the same DL PDSCH data during the UE tune away period. Therefore, the eNB will not transmit any new data to the UE while the UE is in the transmission freeze state, and no data will be missed.

The exit transmission freeze component 1014 can exit the transmission freeze state at the end of the predetermined interval. For example, the predetermined interval of the transmission freeze state can be 4-5 ms immediately preceding the start of the tune away procedure. The predetermined interval of the transmission freeze state may be configurable using the software configuration parameters of the UE. In aspect, the UE can exit the transmission freeze state based on signaling received from the eNB that is received at the reception component 1004. When the UE exits the transmission freeze state, the transmission component 1016 can be enabled. After exiting the transmission freeze state, the UE can continue to receive and decode DL PDSCH scheduled data at the reception component 1004, and also transmit any UL ACK/NACK for that data using the enabled transmission component 1016. In other words, during the transmission freeze state, the UE can successfully receive DL PDSCH data from the eNB 1050 and also provide UL ACK/NACK to the eNB 1050 for this data.

In addition, the determination component 1010 can determine if a transmission from the eNB 1050 received (e.g., by the reception component 1004) and decoded while in a transmission freeze state. If the determination component 1010 determines that the transmission was received and decoded while not in the transmission freeze state, the transmission component 1016 can transmit an ACK/NACK related to the received and decoded transmission to the eNB 1050. However, if the determination component 1010 determines that the transmission was received and decoded while in the transmission freeze state, then the transmission component 1016 may not send an ACK/NACK related to the transmission to the eNB 1050. Consequently, when the UE 1002 is in the transmission freeze state, the eNB 1050 will not receive an UL ACK/NACK for transmissions sent to the UE 1002 during this time period. Since no UL ACK/NACK is received, the eNB 1050 can then retransmit the same transmission to the UE, which is now tuned away to the second network. This may prevent the eNB 1050 from transmitting new DL PDSCH data to the UE 1002 during the tune away period. As such, after exit tune away component 1008 tunes back to the first network (e.g., LTE network), the UE 1002 will not send an RLC PDU NACK for data received during the transmission freeze period.

The apparatus may include additional components that perform each of the blocks of the algorithm in the aforementioned flowcharts of FIGS. 8 and 9. As such, each block in the aforementioned flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

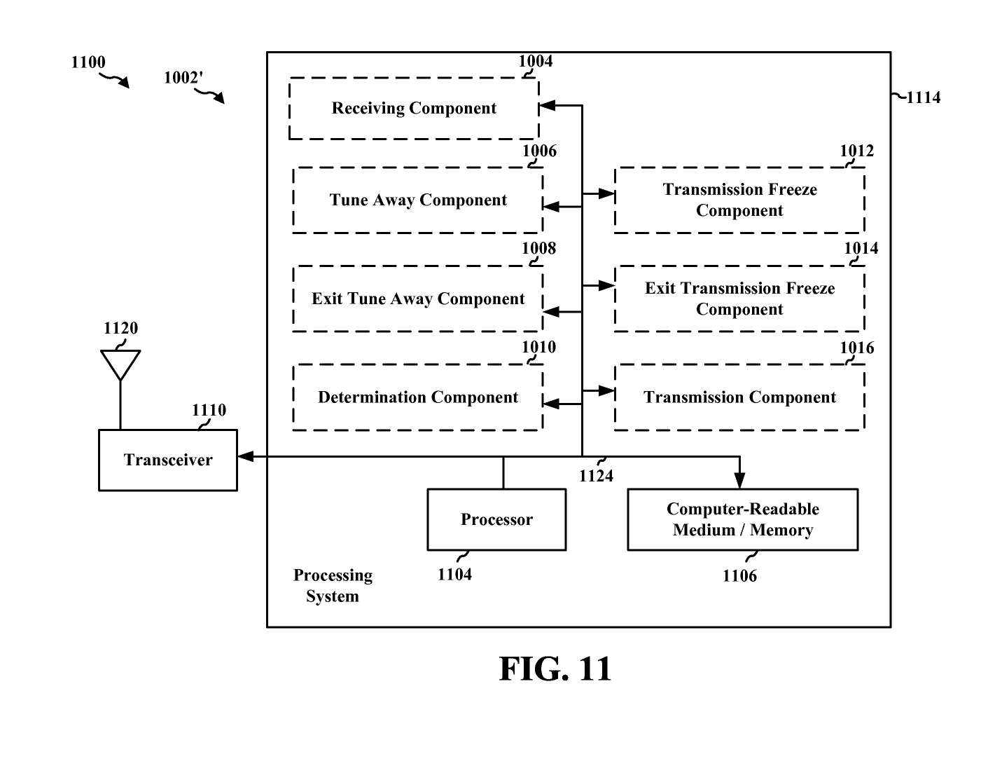

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, 1014, 1016, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1016, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system further includes at least one of the components 1004, 1006, 1008, 1010, 1012, 1014, 1016. The components may be software components running in the processor 1104, resident/stored in the computer readable medium/memory 1106, one or more hardware component coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication includes means for means for establishing a wireless connection to a first network. In an aspect, the wireless communication further includes means for determining a start time of a tune away procedure. In a further aspect, the wireless communication includes means for entering a transmission freeze state for a first predetermined interval prior to the start time of the tune away procedure. In another aspect, the wireless communication includes means for tuning away from the first network for a second predetermined interval. In still a further aspect, the wireless communication includes means for tuning back to the first network after the second predetermined interval. Furthermore, in an aspect, the wireless communication includes means for receiving at least one transmission during the first predetermined interval. Moreover, in an aspect, the wireless communication includes means for decoding the at least one transmission during the first predetermined interval. In an aspect, an acknowledgement (ACK) or a negative acknowledgement (NACK) related to the received and decoded at least one transmission is not transmitted during the first predetermined interval. In another aspect, a NACK related to the received and decoded at least one transmission is not transmitted after tuning back to the first network. In another aspect, the decoding includes a hybrid automatic repeat request (HARQ) process. In a further aspect, the wireless communication includes means for exiting the transmission freeze state at the start time of the tune away procedure. In an aspect, new transmissions are not received during the second predetermined interval. In another aspect, new HARQ processes are not initiated during the second predetermined interval. In a further aspect, the first predetermined time period is configurable. In another aspect, the means for tuning away from the first network is configured to tune to a second network during the second predetermined interval.

The aforementioned means may be one or more of the aforementioned components of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of transmission control for a user equipment (UE), comprising:
establishing a wireless connection to a first network;
determining a start time of a tune away procedure;
entering a transmission freeze state for a first predetermined interval prior to the start time of the tune away procedure;
tuning away from the first network for a second predetermined interval; and
tuning back to the first network after the second predetermined interval.

2. The method of claim 1, further comprising receiving and decoding at least one transmission during the first predetermined interval.

3. The method of claim 2, wherein an acknowledgement (ACK) or a negative acknowledgement (NACK) related to the received and decoded at least one transmission is not transmitted during the first predetermined interval.

4. The method of claim 2, wherein a NACK related to the received and decoded at least one transmission is not transmitted after tuning back to the first network.

5. The method of claim 2, wherein the decoding includes a hybrid automatic repeat request (HARQ) process.

6. The method of claim 1, further comprising exiting the transmission freeze state at the start time of the tune away procedure.

7. The method of claim 6, wherein new transmissions are not received during the second predetermined interval.

8. The method of claim 7, wherein new HARQ processes are not initiated during the second predetermined interval.

9. The method of claim 1, wherein the first predetermined time period is configurable.

10. The method of claim 1, wherein tuning away from the first network includes tuning to a second network during the second predetermined interval.

11. An apparatus for wireless communication, comprising:
means for establishing a wireless connection to a first network;
means for determining a start time of a tune away procedure;
means for entering a transmission freeze state for a first predetermined interval prior to the start time of the tune away procedure;
means for tuning away from the first network for a second predetermined interval; and
means for tuning back to the first network after the second predetermined interval.

12. The apparatus of claim 11, further comprising:
means for receiving at least one transmission during the first predetermined interval; and
means for decoding the at least one transmission during the first predetermined interval.

13. The apparatus of claim 12, wherein an acknowledgement (ACK) or a negative acknowledgement (NACK) related to the received and decoded at least one transmission is not transmitted during the first predetermined interval.

14. The apparatus of claim 12, wherein a NACK related to the received and decoded at least one transmission is not transmitted after tuning back to the first network.

15. The apparatus of claim 12, wherein the decoding includes a hybrid automatic repeat request (HARQ) process.

16. The apparatus of claim 11, further comprising means for exiting the transmission freeze state at the start time of the tune away procedure.

17. The apparatus of claim 16, wherein new transmissions are not received during the second predetermined interval.

18. The apparatus of claim 17, wherein new HARQ processes are not initiated during the second predetermined interval.

19. The apparatus of claim 11, wherein the first predetermined time period is configurable.

20. The apparatus of claim 11, wherein the means for tuning away from the first network is configured to tune to a second network during the second predetermined interval.

21. An apparatus for wireless communication, comprising:
a memory; and
at least one processor coupled to the memory and configured to:
establish a wireless connection to a first network;
determine a start time of a tune away procedure;
enter a transmission freeze state for a first predetermined interval prior to the start time of the tune away procedure;
tune away from the first network for a second predetermined interval; and
tune back to the first network after the second predetermined interval.

22. The apparatus of claim 21, wherein the at least one processor coupled to the memory is further configured to receive and decode at least one transmission during the first predetermined interval.

23. The apparatus of claim 22, wherein an acknowledgement (ACK) or a negative acknowledgement (NACK) related to the received and decoded at least one transmission is not transmitted during the first predetermined interval.

24. The apparatus of claim 22, wherein a NACK related to the received and decoded at least one transmission is not transmitted after tuning back to the first network.

25. The apparatus of claim 22, wherein the at least one processor coupled to the memory is further configured to implement a hybrid automatic repeat request (HARQ) process.

26. The apparatus of claim 21, wherein the processor coupled to the memory is further configured to exit the transmission freeze state at the start time of the tune away procedure.

27. The apparatus of claim 26, wherein new transmissions are not received during the second predetermined interval.

28. The apparatus of claim 27, wherein new HARQ processes are not initiated during the second predetermined interval.

29. The apparatus of claim 21, wherein the first predetermined time period is configurable.

30. The apparatus of claim 21, wherein the processor coupled to the memory is further configured to tune to a second network during the second predetermined interval.
